(19) United States
(12) Patent Application Publication
(10) Pub. No.: US 2026/0004579 A1
(43) Pub. Date: Jan. 1, 2026

(54) DETERMINING OUTLIER IMAGES BASED ON CATEGORY-BASED IMAGE RELEVANCE USING EMBEDDING NEURAL NETWORKS

(71) Applicant: Microsoft Technology Licensing, LLC, Redmond, WA (US)

(72) Inventors: Juan Carlos ANGELES CERON, Bellevue, WA (US); Harshit JAIN, Redmond, WA (US); Jyotkumar Jagdishbhai PATEL, Bellevue, WA (US)

(21) Appl. No.: 18/755,529

(22) Filed: Jun. 26, 2024

(51) Int. Cl. G06V 20/00; G06V 10/82; G06V 20/70

(52) U.S. Cl. CPC G06V 20/35; G06V 10/82; G06V 20/70

(57) ABSTRACT

This disclosure describes a framework for determining the category-based image relevance of digital images associated with entities or topics. Specifically, this disclosure describes an image relevance system that determines outlier images within a set of images associated with an entity or topic by correlating semantic content with visual content. For example, the image relevance system ensures that only images relevant to the entity or topic are provided in response to a user query about the entity or topic. The image relevance system can also filter out images from an image set that do not correspond to user input in a search query before providing the image set. Furthermore, the image relevance system can prevent irrelevant images from being added to an image set associated with an entity or topic.

### BACKGROUND

In recent years, significant advancements have been made in both the hardware and software domains, particularly in the area of web searches and information retrieval. For instance, in response to a user providing a search query for a topic, a web search system provides search results with information about the topic. Often, the search results include images related to the search topic. However, some of the provided images in the search results misrepresent the search topic. One reason for this problem is that many current web search systems rely on feature similarity to identify related images. Because images with very different semantic meanings can have similar visual features, many current systems provide irrelevant images that have visual similarities with relevant images. Furthermore, many current systems are unable to determine when images are unrelated to a topic. Accordingly, these current systems provide images tagged to a topic regardless of their relevance. These and other issues exist with current web search systems.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of an image relevance system that utilizes category-specific relevance thresholds to discover and remove outlier images.

FIG. 2 illustrates an example computing environment in which the image relevance system is implemented.

FIG. 3 illustrates an example flow diagram of the image relevance system determining outlier and non-outlier images based on category-specific embeddings and category-specific relevance thresholds.

FIG. 4 illustrates an example flow diagram for determining text embeddings for a category label.

FIG. 5 illustrates an example flow diagram for determining image embeddings for an image.

FIG. 6 illustrates an example flow diagram for determining a category-specific relevance threshold for a category label.

FIGS. 7A-7B illustrate example graphical user interface diagrams for providing search results with a topic-specific image set before (FIG. 7A) and after (FIG. 7B) the image relevance system determines and removes an outlier image.

FIG. 8 illustrates an example flow diagram of adding relevant images to a topic-specific image set.

FIG. 9 illustrates an example series of acts of a computer-implemented method for determining the relevance of a digital image based on a category-specific embedding.

FIG. 10 illustrates an example series of acts of a computer-implemented method for determining the relevance of digital images based on category-specific embeddings.

FIG. 11 illustrates example components included within a computer system used to implement the image relevance system.

### DETAILED DESCRIPTION

This disclosure describes a framework for determining the category-based image relevance of digital images associated with entities or topics. Specifically, this disclosure describes an image relevance system that correlates semantic content (e.g., category labels) with visual content to identify outlier images within a set of images associated with an entity or topic. In various implementations, the image relevance system removes outlier images and provides only relevant images to a client device, particularly in response to a user query about the entity or topic. In some implementations, the image relevance system filters out images from a specific image set that do not correspond to additional user input in the search query before providing the filtered set of images. Moreover, one or more implementations of the image relevance system ensure that only relevant images are associated with the entity to avoid providing irrelevant and confusing images to users in response to future queries about the entity or topic.

Implementations of the present disclosure provide benefits and solve problems in the art with systems, computer-readable media, and computer-implemented methods that utilize the image relevance system to determine, rank, and/or remove images based on their semantic relevance to an entity or topic (and user input in some cases). In particular, the image relevance system utilizes various embedding neural networks along with a generative artificial intelligence (AI) model to determine whether images in an image set associated with an entity or topic are semantically relevant to the entity or topic. For example, the image relevance system uses similarity thresholds specific to the category of an entity or topic to determine whether a purportedly relevant image is indeed relevant. The image relevance system may remove the irrelevant and confusing images from the image set before providing the image set to a client device in response to a user query about the entity or topic.

For context, a client device may provide a search query (e.g., a user query) that includes user input indicating an entity or topic. In response, a user query system identifies, aggregates, and returns content and information about the entity or topic, such as one or more categories (e.g., category labels) that classify the entity or topic and images associated with the entity or topic. However, the set of images associated with the entity or topic can include confusing images that are irrelevant and unrelated to the entity or topic. In many instances, the image relevance system detects image relevance to the entity or topic and removes the irrelevant images. In some instances, the image relevance system ranks the set of images before returning them in response to the user query as part of a multimodal response.

To illustrate how the image relevance system determines the relevance of a digital image based on a category-specific embedding, the image relevance system can generate a text embedding based on the category label, and in some cases, the user input. In various instances, the user input is used to identify an entity or topic with an assigned category label. Additionally, the image relevance system can obtain an image embedding for an image that belongs to a set of images identified based on the user input (e.g., images assigned to the entity or topic identified from the user input). The image relevance system may also generate a similarity score by combining the text embedding and the image embedding. By comparing the similarity score to a category-specific relevance threshold, the image relevance system determines when the image is an outlier image for the set of images and removes it from the image set. Additionally, in response to the original user input (e.g., the user query), the image relevance system provides the image set without the outlier image.

In some implementations, the image relevance system also determines the relevance of digital images based on category-specific embeddings. For example, the image relevance system receives a first image and a second image associated with a category label. In response, the image relevance system generates a first image embedding for the first image and a second image embedding for the second image. Additionally, the image relevance system generates a first similarity score between the text embedding for the category label and the first image embedding, as well as a second similarity score between the text embedding for the category label and the second image embedding. If the first similarity score meets the category-specific relevance threshold for the category label, the image relevance system adds the first image to a set of images associated with the category label. Similarly, if the second similarity score does not meet the category-specific relevance threshold for the category label, the image relevance system does not add the second image to the set of images associated with the category label.

As described in this disclosure, the image relevance system delivers several significant technical benefits in terms of improved accuracy and efficiency compared to current web search systems. Moreover, the image relevance system provides several practical applications that address problems related to improving the accuracy and efficiency of determining and removing outlier images in an image set using category-based image relevance and category-specific relevance thresholds.

As mentioned above, many current systems provide image sets that include semantically different images that do not correspond to a target entity or topic. Often, irrelevant images are located next to relevant images for a target entity or topic in embedding space because they share visual similarities. Accordingly, these irrelevant images are often incorrectly provided when presenting an image set for the target entity or topic.

In contrast to current systems, the image relevance system uses semantic similarity for a better category understanding. For example, the image relevance system generates text embeddings based on category labels, and in some cases, user input, for a target entity or topic. Additionally, the image relevance system obtains image embeddings for images associated with the target entity or topic. Furthermore, the image relevance system determines similarities (e.g., similarity score) between the text and image embeddings. The image relevance system then utilizes these similarity scores to accurately determine which images are relevant to the target entity or topic.

In various implementations, the image relevance system utilizes embedding neural networks, such as deep learning models to generate text and image embeddings, which are computationally inexpensive compared to generative artificial intelligence (AI) models. In some implementations, the text and/or image embeddings are stored in a cache or data store, which saves memory by not storing large images. By using cached data and/or computationally inexpensive models, the image relevance system efficiently determines outlier images for an image set. This also allows for real-time processing in determining outlier images, especially when user input is factored into generating new text embeddings and similarity scores to filter out images in an image set that are irrelevant to a specific user query. Additionally, using cached data and/or computationally inexpensive models also allows the image relevance system to scale smoothly without manual intervention.

The image relevance system also provides improved accuracy in various implementations. For instance, the image relevance system utilizes a category-specific relevance threshold that is tailored for each category. Additionally, when a category has multiple hierarchical labels, the image relevance system can apply different category-specific relevance thresholds corresponding to the particular hierarchical label applied to the images (e.g., often the most granular label). By using a category-specific relevance threshold, each set of images is evaluated based on similarity threshold values that are specific to the particular category label associated with the target entity or topic, which improves the accuracy of identifying and removing outlier images for an image set. Indeed, the image relevance system provides accurate and relevant results when many current systems provide inaccurate, confusing, and irrelevant image results in response to user queries.

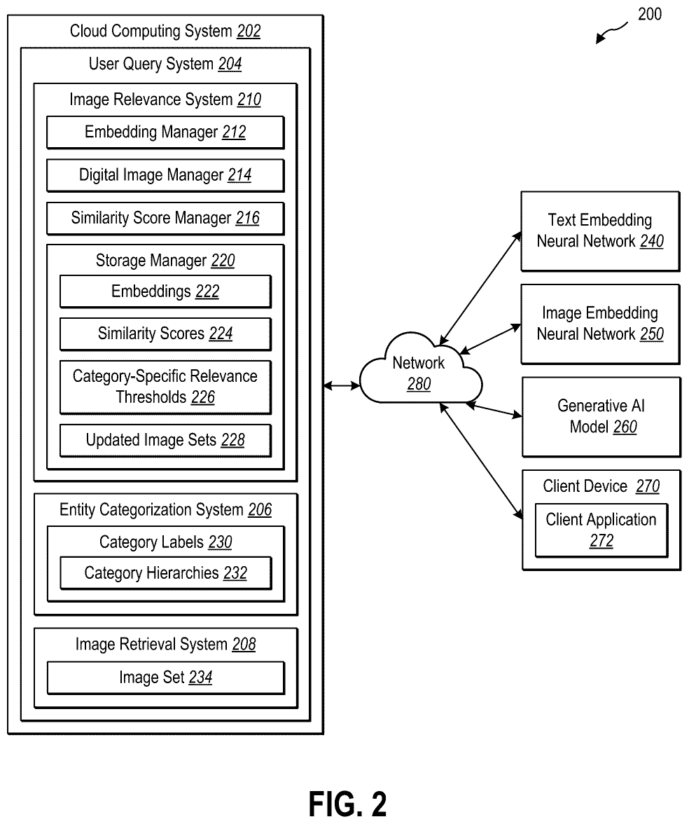

As illustrated in the preceding discussion, this disclosure uses a variety of terms to describe the features and advantages of one or more described implementations. For example, this disclosure describes search engine indexing in the context of a cloud computing system. As an example, the term “cloud computing system” refers to a network of interconnected computing devices that provide various services and applications to computing devices (e.g., server devices and client devices) inside or outside of the cloud computing system. An example of a cloud computing system is described below in connection with FIG. 2.

As an example, the term “digital image” (or simply “image”) refers to a digital graphics file that, when rendered, displays one or more objects. Images may be grouped into sets or collections based on various associations. For example, a set of images may correlate to images assigned or associated with an entity or topic. As another example, a collection of images may correspond to images assigned or associated with a category label.

As another example, the term “entity” refers to a distinct, identifiable unit, such as an organization, company, business, individual, person, location, event, experience, group, attraction, item, or a set of multiple units. Entities can be identified by an entity identifier, which often uniquely identifies the entity. Additionally, an entity can often be linked to a physical location. Similarly, as an example, the term “topic” refers to a specific subject, theme, or matter. Topics can be identified by a topic identifier. In various instances, an entity or a topic serves as the subject of a user query, which includes user input indicating the entity or topic.

As an example, the term “category” refers to a classification of an entity or topic within a set of classifications where items in a category share common characteristics, properties, or qualities. Categories are identified by category labels. An entity or topic may be associated with multiple different categories. Additionally, categories may be organized into a hierarchy or taxonomy rank, with different levels of granularity. For instance, an entity may be categorized with different hierarchical levels of a category, such as a first category level, a second category level, and/or one or more additional category levels. For example, if Entity A is a particular animal store, Entity A may have a first-level category label of “Retail,” a second-level category label of “Shopping,” a third-level category label of “Pet Store,” and a fourth-level category label of “Exotic Pet Store.”

As an example, the terms “user query,” “search query,” and “user search query” (or simply “query”) refer to data received from a user or a system regarding an entity or topic. For example, a user interface provides an interactive interface that includes an input field for a user to provide user input in a query. Similarly, the term “user input” refers to input provided within the query that indicates an entity or topic (e.g., “Entity A”). In some instances, user input also includes descriptive keywords, clarifying content, or metadata focusing on or narrowing the search scope associated with the entity or topic (e.g., “Parking at Entity A,” “Entity A at Night,” “Hotel B's Amenities”). In response to receiving a query, one or more systems provide a response to the query that includes information about the entity or topic. In some instances, the response includes a set of one or more images associated with the entity or topic. As described below, the image relevance system can remove irrelevant outlier images in the image set before they are provided in the query response.

As an example, the term “machine-learning model” refers to a computer model or computer representation that can be trained (e.g., optimized) based on inputs to approximate unknown functions. For instance, a machine-learning model can include (but is not limited to) an autoencoder model, an embedding model, a classification model, a neural network, a decision tree (e.g., a gradient-boosted decision tree), a linear regression model, a logistic regression model, or a combination of these models.

As another example, the term “neural network” refers to a machine learning model comprising interconnected artificial neurons that communicate and learn to approximate complex functions, generating outputs based on multiple inputs provided to the model. For instance, a neural network includes an algorithm (or set of algorithms) that employs deep learning techniques and utilizes training data to adjust the parameters of the network and model high-level abstractions in data. Machine learning models and neural networks use fewer parameters and are much more computationally inexpensive and efficient compared to generative artificial intelligence (AI) models. Various types of neural networks exist, such as convolutional neural networks (CNNs), embedding neural networks (e.g., a text embedding neural network or an image embedding neural network), residual learning neural networks, recurrent neural networks (RNNs), generative neural networks, generative adversarial neural networks (GANs), and single-shot detection (SSD) networks.

As an example, the terms “vector embedding” and “embedding” refer to a numerical learned representation of an object, item, or data structure. For example, the term “text embedding” refers to a learned representation of text, where words with similar meanings share similar vectors in a continuous vector space. As another example, the term “image embedding” refers to a learned representation of an image, where the visual features and semantic content of the image are encoded into dense vectors. Embedding neural networks, such as a text embedding neural network and an image embedding neural network, can generate text embeddings and image embeddings from text strings and images, respectively.

As an example, the term “similarity score” refers to a measure of similarity between two embeddings, which can include different embedding types. In some instances, a similarity score occurs in an inner product space. In various instances, the similarity score is a cosine similarity (e.g., the cosine of the angle between the vectors determined by the dot product of the vectors divided by the product of their lengths).

As another example, the term “category-specific relevance threshold” refers to a specific threshold level or value that is used to determine outlier images for a category label. The category-specific relevance threshold is specific to the category label. If a similarity score associated with an image does not meet, satisfy, or exceed the category-specific relevance threshold for a category label, the image is an outlier image and should not be included in an image set associated with the category label (e.g., with an entity or topic with the category label). A category with multiple category hierarchy levels can have a category-specific relevance threshold for each level.

As an example, the term “generative artificial intelligence model” (or “generative AI model”) refers to a computational system that utilizes deep learning and a large number of parameters (e.g., billions or trillions for a large version and fewer for a small version) that are trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations.

Moreover, generative AI models are primarily based on transformer architectures for understanding, generating, and manipulating human language. Generative AI models can also utilize other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models like GPT-3.5, GPT-4, and GPT-40, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), a small language model (SLM), and a small action model (SAM), which serve as text-based versions of a generative AI model, such as ones that receive text prompts and/or generate text outputs. In various implementations, a generative AI model is a multimodal generative model that receives multiple input formats (e.g., text, images, video, data structures) and/or generates multiple output formats.

As another example, the terms “prompt,” “model prompt,” or “generative AI model prompt” refer to a request provided to a large generative image model to create generative AI model output based on plain language guidance prompts. In various instances, the prompt is an image relevance prompt requesting an image relevance evaluation of a collection of images associated with an entity or a topic.

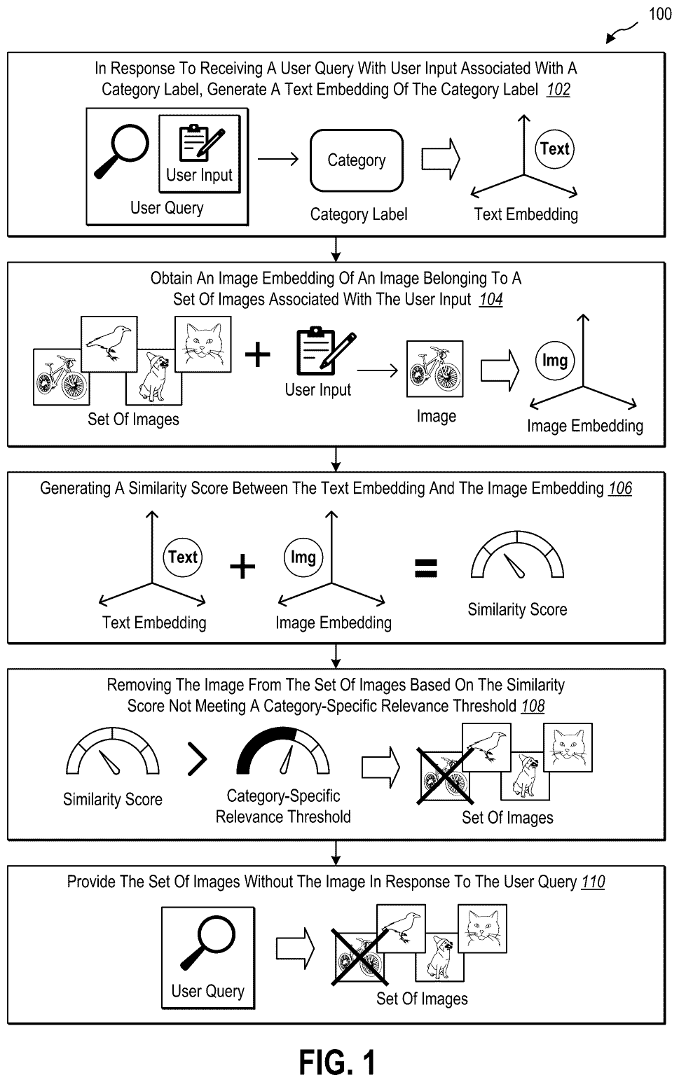

Implementation examples and details of the image relevance system will be discussed in connection with the accompanying figures, which will be described next. For example, FIG. 1 illustrates an example of an image relevance system that utilizes category-specific relevance thresholds to discover and remove outlier images according to some implementations. While FIG. 1 provides a high-level overview of the invention, additional details are provided in subsequent figures.

FIG. 1 illustrates a series of acts 100 performed by or in connection with the image relevance system. As shown, the series of acts 100 briefly illustrates an example of how the image relevance system utilizes embedding similarities and a category-specific relevance threshold for a category label to remove an outlier image from a set of images. In various implementations, the series of acts 100 corresponds to a user query with user input that identifies an entity. In some instances, the entity is presumed to be a geographically local instance of the entity, unless a location is provided in the user query.

The series of acts 100 includes act 102 of generating a text embedding of a category label in response to receiving a user query with user input associated with the category label. For example, upon a user providing the user query with user input identifying an entity having an entity identifier, a user query system identifies a category label for the entity identifier. In various implementations, the image relevance system generates or obtains a text embedding for the category label. In some implementations, the text embedding is based on the entity included in the user input and the category label.

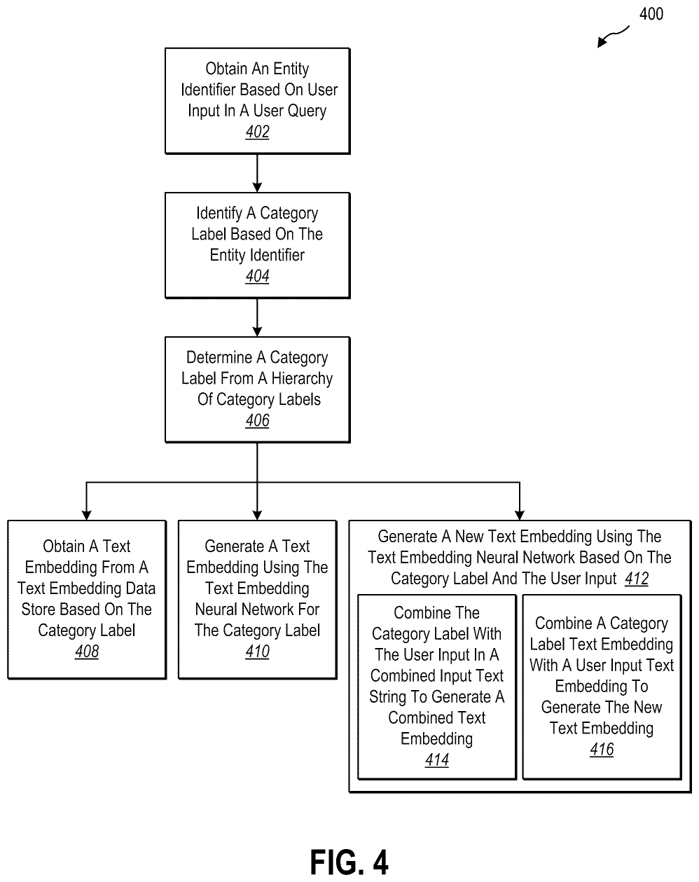

In some implementations, the user input includes additional keywords, metadata, or content that focuses the entity search on a particular scope or aspect. In these instances, the image relevance system may combine the keyword or content with the classification label and generate a new text embedding. In various implementations, the image relevance system utilizes a text embedding neural network to generate text embeddings from input text strings. Additional details about generating text embeddings are provided below in connection with FIG. 4.

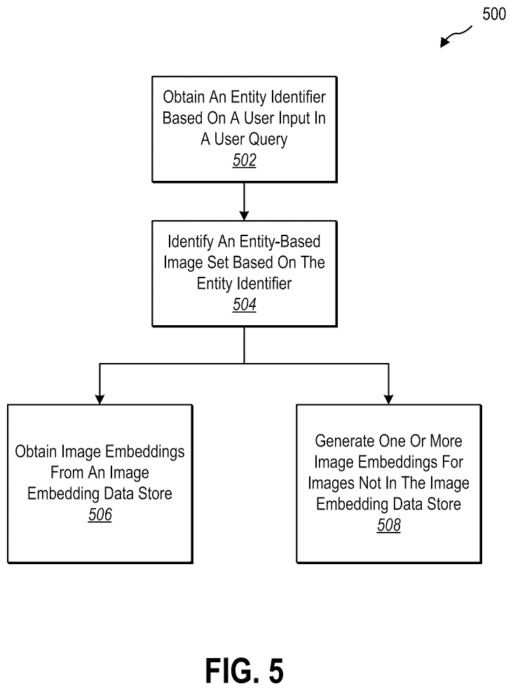

Act 104 includes obtaining an image embedding of an image belonging to a set of images associated with the user input. Based on the user input in the user query being used to identify the entity having the entity identifier, a set of images associated or tagged with the entity identifier can be identified. The image relevance system can obtain image embeddings for images in the image set associated with the entity identifier if previously generated, or the image relevance system can generate image embeddings if needed. As shown, act 104 includes obtaining an image embedding for an image (e.g., a target image) within the image set associated with the entity identifier. Additional details about obtaining image embeddings are provided below in connection with FIG. 5.

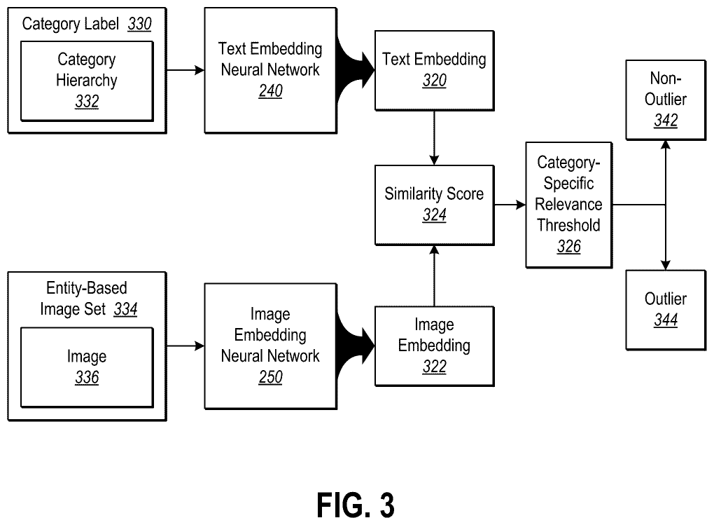

Act 106 includes generating a similarity score between the text embedding and the image embedding. In various implementations, the image relevance system determines a similarity measure between the image and the category label by combining the text embedding with the image embedding. For example, the similarity score is based on cosine similarity. Additional details about generating similarity scores are provided below in connection with FIG. 3.

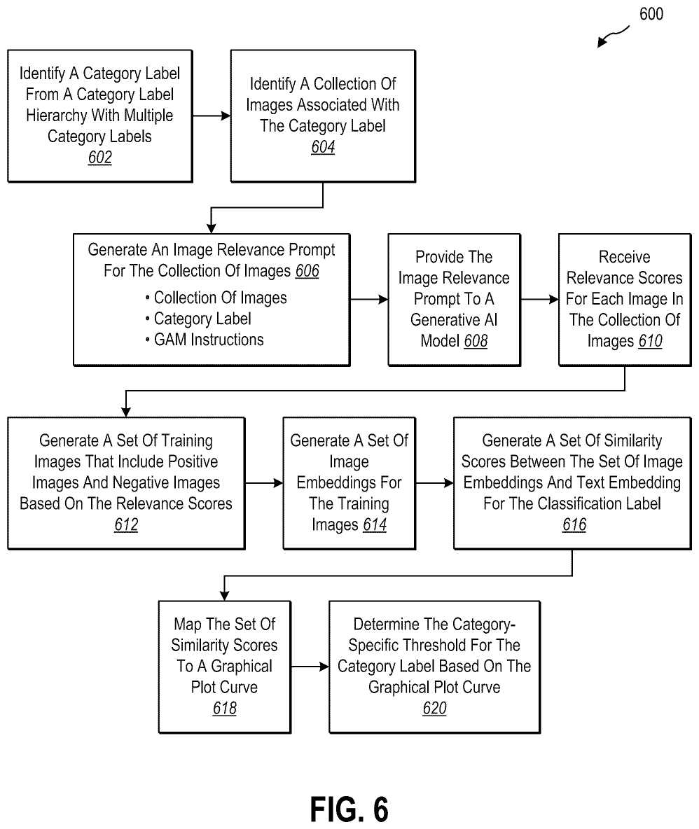

Act 108 includes removing the image from the set of images based on the similarity score not meeting a category-specific relevance threshold. For instance, the image relevance system compares the generated similarity score with a category-specific relevance threshold determined for the category label to determine if the image is an outlier for the image set. Based on the similarity score not satisfying the category-specific relevance threshold, the image relevance system removes the image from the set of images associated with the entity. Additional details about generating category-specific relevance thresholds for category labels are provided below in connection with FIG. 6.

In various implementations, the image relevance system temporarily removes an outlier image from a set of images. For instance, if the text embedding is also based on additional keywords in the user query that focus on the scope of the user query (e.g., Landmark A at night), then the image relevance system uses the similarity scores and the category-specific relevance threshold to temporarily remove images from the image set that do not correspond to the user query.

Act 110 includes providing the set of images within the image in response to the user query. For instance, the image relevance system or another system, such as a user query system, provides search results to a user in response to the user query, which includes the updated version of the set of images without the outlier image.

In various implementations, the image relevance system uses image rank to provide the image set. For example, for non-outlier relevant images, the image relevance system ranks the images based on their similarity scores, with higher similarity score images being selected for display above lower similarity score images. In various implementations, the image relevance system uses ranking to determine which images from the image set to provide when fewer than all of the images can be provided to a user in the query response.

With a general overview in place, additional details are provided regarding the components, features, and elements of the image relevance system. To illustrate, FIG. 2 shows an example computing environment where the image relevance system is implemented according to some implementations. In particular, FIG. 2 illustrates an example of a computing environment 200 with various computing devices including a cloud computing system 202 associated with an image relevance system 210, a text embedding neural network 240, an image embedding neural network 250, a generative AI model 260, and a client device 270, connected via a network 280. While FIG. 2 shows example arrangements and configurations of the computing environment 200, the cloud computing system 202, the image relevance system 210, and associated components, other arrangements and configurations are possible.

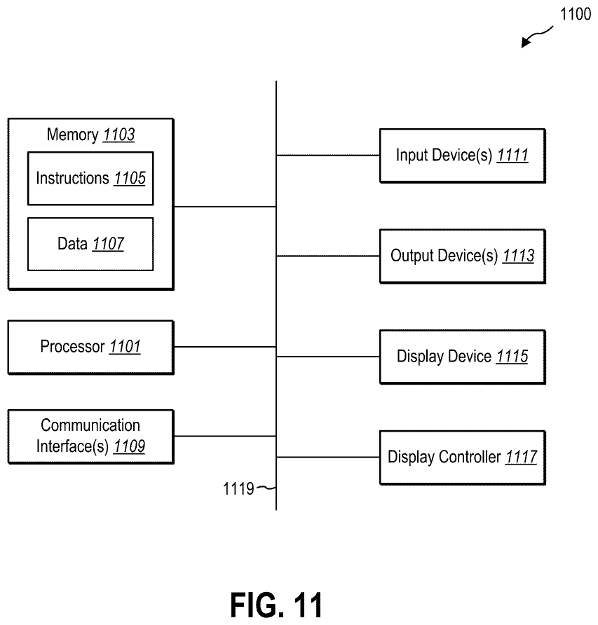

Many of these components shown may be implemented on one or more computing devices, such as on one or more server devices. In various implementations, some of these components (e.g., the cloud computing system 202, the text embedding neural network 240, the image embedding neural network 250, the generative AI model 260, and the client device 270) represent multiple component instances or component versions (e.g., the generative AI model 260 represents different versions of a generative model). Further details regarding computing devices are provided below in connection with FIG. 11, which also includes additional details regarding networks, such as the network 280 shown.

Before describing the components of the cloud computing system 202, including the image relevance system 210, other components of the computing environment 200 are discussed first to provide better context when describing the image relevance system 210. For example, the text embedding neural network 240 represents one or more text embedding or encoding neural networks. In various implementations, the text embedding neural network 240 is a pre-trained neural network to generate text embeddings or text vectors in text embedding space based on input text strings. The image embedding neural network 250 may represent one or more image embedding or encoding neural networks. In various implementations, the image embedding neural network 250 is a pre-trained neural network to generate image embeddings or image vectors in dense image embedding space based on input images.

In various implementations, the generative AI model 260 represents one or more generative models or multiple model instances. The generative AI model 260 may produce generative outputs (e.g., AI model outputs) based on prompt inputs (e.g., AI model prompts). For example, the generative AI model 260 generates relevance results for a collection of input images based on their correlation to a category label when provided with an image relevance prompt. In some implementations, the generative AI model 260 is an image-based generative AI model (e.g., GPT-V) that determines and uses image contexts to analyze and process input images.

As shown, the computing environment 200 includes the client device 270 with a client application 272. In various instances, the client device 270 includes a client application 272, such as a web browser, mobile application, or another type of computer application used to access and/or interact with the cloud computing system 202 and/or the image relevance system 210. In various implementations, the client device 270 is associated with a user (e.g., a user client device), such as a user who regularly engages in user queries using the client application 272.

Returning to the cloud computing system 202, as shown, the cloud computing system 202 includes a user query system 204. The user query system 204 facilitates user queries about entities or topics where query results are provided in response to the user queries. As shown, the user query system 204 includes the image relevance system 210, an entity categorization system 206, and an image retrieval system 208.

In various implementations, the entity categorization system 206 determines one or more category labels and/or category label levels for an entity (or topic) included in the user input of a user query. As shown, the entity categorization system 206 includes category labels 230 with category hierarchies 232. In some implementations, the image relevance system 210 may obtain a category label from the entity categorization system 206.

In one or more implementations, the image retrieval system 208 obtains images for an entity identified based on user input included in a user query. As shown, the image retrieval system 208 includes image sets 234, which include images associated with a given entity or topic. In some implementations, the image relevance system 210 may obtain a set of images or corresponding image embeddings from the image retrieval system 208.

In some implementations, the image relevance system 210 is located on a separate computing device from the user query system 204 within the cloud computing system 202 (or apart from the cloud computing system 202). In various implementations, the image relevance system 210 operates independently of the user query system 204.

In various implementations, including the illustrated implementation, the image relevance system 210 includes various components and elements implemented in hardware and/or software. For example, the image relevance system 210 includes an embedding manager 212, a digital image manager 214, a similarity score manager 216, and a storage manager 220. The storage manager 220 includes embeddings 222, similarity scores 224, category-specific relevance thresholds 226, and updated image sets 228.

In one or more implementations, the embedding manager 212 manages embeddings 222 (e.g., text and image embeddings). In various implementations, the embedding manager 212 communicates with the text embedding neural network 240 and/or the image embedding neural network 250 to directly or indirectly obtain the embeddings 222. In addition, the image relevance system 210 includes the digital image manager 214, which obtains the image sets 234 for an entity or topic to assess the images for category-based relevance.

As shown, the image relevance system 210 includes the similarity score manager 216 that determines similarity scores 224 based on the embeddings 222. In some implementations, the similarity score manager 216 compares the similarity scores 224 to the category-specific relevance thresholds 226 to determine outlier images for an image set associated with an entity or topic. Upon removing the outliers, the similarity score manager 216 may generate updated image sets 228 for the entity or topic, which are provided in response to a user query.

Turning to the next set of figures, these figures illustrate examples of the image relevance system 210 performing different processes to determine outlier images. To begin, FIG. 3 provides a more detailed overview of the image relevance system 210. In particular, FIG. 3 illustrates an example flow diagram of the image relevance system determining outlier and non-outlier images based on category-specific embeddings and category-specific relevance thresholds according to some implementations. While FIG. 3 refers to implementations of the image relevance system 210 in terms of an entity, the same principles also apply to topics.

As mentioned, FIG. 3 corresponds to determining whether an image is relevant to an entity (e.g., whether the image is an outlier or non-outlier). For context, FIG. 3 starts with having a category label for an entity and an image from a set of images assigned to the entity. In many instances, the entity is identified based on user input in a user query. For example, in response to a user query, a user query system identifies the entity, identifies a category label for the entity, and identifies a set of images associated with or assigned to the entity.

In many instances, an entity represents a local entity geographically near the client device providing the user query. For example, unless the user input in the user query specifies another location, the user query system uses the location of the client device to select a close or closest instance of the entity. Additionally, while multiple instances of an entity may be assigned the same category label, each instance of an entity may be associated with a separate set of images (e.g., Restaurant A at Location A is assigned a different image set than Restaurant A at Location B, even if some images overlap).

As shown, FIG. 3 includes an upper path related to text embeddings and a lower path related to image embeddings. The upper path includes a category label 330 with a category hierarchy 332, the text embedding neural network 240, and a text embedding 320. The lower path includes an entity-based image set 334 with an image 336, the neural network 250, and an image embedding 322.

As shown in the upper path, the image relevance system 210 generates a text embedding 320 from the category label 330 using the neural network 240. When the category label 330 is part of a category hierarchy 332, the image relevance system 210 may combine or concatenate each hierarchy level into an input text string. For example, given the category label of “Pet Store” with a full hierarchy of “Retail|Shopping|Pet Stores,” the image relevance system 210 generates a text embedding based on an input that includes each phrase in the full hierarchy.

In various implementations, different entities are assigned to different category hierarchy levels of a category label. In many instances, the image relevance system 210 determines a text embedding based on the most granular or specific category label available for the entity (e.g., an input string that combines the category label at each category hierarchy level). Using input text for each of the category hierarchy levels often results in a more precise text embedding. In some instances, the image relevance system 210 generates a text embedding based on only one or a subset of the category labels in the category hierarchy 332.

As mentioned, the image relevance system 210 uses the category label 330 (or a set of category hierarchy labels) for an entity to determine the text embedding 320. In some implementations, the image relevance system 210 also uses keywords from the user input to generate the text embedding 320. For instance, when the user input in a user query includes keywords in addition to naming an entity, the image relevance system 210 may also combine or concatenate the keywords into an input text string provided to the text embedding neural network 240 to generate the text embedding 320.

To illustrate the above instance, if the user input is “A1-Pets parking” or “A1-Pets cats for sale,” the image relevance system 210 identifies the keywords “parking” or “cats” (or “cats for sale”). In these cases, the image relevance system 210 may generate input text strings that include the category label or category hierarchy labels (e.g., “Retail,” “Shopping,” and “Pet Stores”) with the keywords “parking” or “cats.” The image relevance system 210 then provides the input text strings to the text embedding neural network 240 to generate the corresponding text embeddings. In some implementations, the image relevance system 210 may also add the location of the entity to the input text string.

As shown in FIG. 3, the lower path includes the image relevance system 210 providing an image 336 from an entity-based image set 334 to the image embedding neural network 250 to generate an image embedding 322 of the image. As mentioned, the entity-based image set 334 includes some or all of the images in an image corpus that are assigned, labeled, tagged, or otherwise associated with the entity.

In various implementations, another system generates the image embedding 322, which the image relevance system 210 obtains. For example, an image retrieval system generates and stores image embeddings for each image in the entity-based image set 334 and provides each image embedding upon request by the image relevance system 210. In some instances, the image relevance system 210 accesses an image embedding data store to access the image embedding 322.

FIG. 3 shows the text embedding 320 of the upper path and the image embedding 322 of the lower path converging to create a similarity score 324 that indicates a correlation between the image 336 and at least the category label 330. In one or more implementations, the image relevance system 210 generates the similarity score 324 using cosine similarity between the text embedding 320 and the image embedding 322, as described above. In some implementations, the image relevance system 210 uses other approaches (e.g., dot product similarity) to generate the similarity score 324 between the different embedding types.

As shown, the similarity score 324 is applied to a category-specific relevance threshold 326. For example, the image relevance system 210 identifies a similarity threshold determined specifically for the category label 330 included in the text embedding 320. As discussed further below, each category hierarchy level of a category may have its own category-specific relevance threshold. Additional details about generating category-specific relevance thresholds for category labels are provided below in connection with FIG. 6.

The category-specific relevance threshold 326 can indicate whether the image 336 is an outlier for the entity-based image set 334. To illustrate, if the similarity score 324 meets, satisfies, equals, exceeds, and/or is above the category-specific relevance threshold 326, the image 336 is determined to be a non-outlier 342. Otherwise, if the similarity score 324 is below the category-specific relevance threshold 326, the image 336 is determined to be an outlier 344 for the entity-based image set 334. The image relevance system 210 may then remove the image as an outlier from the entity-based image set 334 before providing the image set in response to a user query.

In some instances, when the text embedding 320 includes only the category label 330 (or a combination of category hierarchy labels), the similarity score 324 satisfies the category-specific relevance threshold 326. However, the text embedding 320 is based on additional keywords from the user input, and the resulting similarity score may not satisfy the category-specific relevance threshold 326. In these implementations, the image relevance system 210 may help to remove irrelevant images from an image set associated with the entity that do not correspond to both the entity and the keywords included in the user query.

As mentioned above, FIG. 4 provides additional details about generating text embeddings. In particular, FIG. 4 illustrates an example flow diagram for determining text embeddings for a category label according to some implementations. As shown, FIG. 4 includes a series of acts 400 performed by or with the image relevance system 210 to generate text embeddings.

The series of acts 400 includes act 402 of obtaining an entity identifier based on user input in a user query. As mentioned earlier, in response to a user query that includes user input, the image relevance system 210 or another system (e.g., a user query system) can identify an entity named or inferred in the user input and identify an entity identifier associated with the entity.

In some implementations, the image relevance system 210 obtains an entity identifier of an entity not connected to a user query. For example, the image relevance system 210 automatically or manually assesses category-based image relevance and removes irrelevant images associated with an entity.

In various implementations, multiple entity identifiers are identified. For example, a user query for Entity A returns a list of different locations of Entity A, each with its own entity identifier. In these implementations, the image relevance system 210 may obtain the entity identifier for the location of the entity that is geographically closest to the location where the user query was generated. In some instances, the image relevance system 210 obtains the entity identifier for a location of the entity specifically mentioned in the user query.

Act 404 includes identifying a category label based on the entity identifier. In various implementations, the image relevance system 210 or another system (e.g., a user query system) identifies a category label associated with the entity identifier. For example, the entity identifier is used as an index value in a category table or database to identify the category label assigned to the entity identifier.

Similarly, act 406 includes determining a category label from a hierarchy of category labels. As mentioned, an entity identifier may be categorized into multiple hierarchy or taxonomy levels within a category. Accordingly, the image relevance system 210 may obtain multiple category labels with different levels of granularity or specificity for an entity identifier. For example, if Entity A is a specialty animal store, Entity A may have a first-level category label of “Retail,” a second-level category label of “Shopping,” a third-level category label of “Pet Store,” and a fourth-level category label of “Exotic Pet Store.” The image relevance system 210 may obtain the most granular category label or each category label associated with the entity identifier.

At this point, the series of acts 400 branches into three different paths. The first path includes act 408 of obtaining a text embedding from a text embedding data store based on the category label. For example, if it is determined that the category label has previously been converted into a text embedding, the image relevance system 210 obtains the stored text embedding. The data store may include different text embeddings for each category hierarchy label for the image relevance system 210 to access.

The second path includes act 410 of generating a text embedding using the text embedding neural network for the category label. For instance, if a text embedding for the category label is not included in the data store or is not accessible, the image relevance system 210 may generate the text embedding by providing the category label as a text string to the text embedding neural network, as described above, to generate the text embedding.

The third path includes act 412 of generating a new text embedding using the text embedding neural network based on the category label and the user input. As mentioned above, in some instances, the image relevance system 210 generates a text embedding that is enriched or enhanced by keywords, metadata, or other content provided in the user input of a user query. For example, using keywords in the user input, the image relevance system 210 identifies a subset of metadata and/or user reviews to include within the text embedding. In the above instances, the image relevance system 210 generates a new text embedding based on both the category label and the keywords and/or content in the user input.

As shown, in a first approach, act 414 includes combining the category label with the user input in a combined input text string to generate a combined text embedding. For example, as described above, the image relevance system 210 generates an input text string that includes both the category label(s) (e.g., “Retail,” “Shopping,” and “Pet Stores”) and keywords (“parking”). The image relevance system 210 then provides the text string as the input to the text embedding neural network to generate a new text embedding.

In a second approach, act 416 includes combining a category label text embedding with a user input text embedding to generate the new text embedding. For example, the image relevance system 210 generates or obtains a category label text embedding for the category label. The image relevance system 210 also generates a user input text embedding based on keywords or other content in the user input. The image relevance system 210 then combines the text embeddings. For example, the image relevance system 210 uses averaging, weighted averaging, majority voting, clustering, or another approach to combine the text embeddings into the new text embedding.

After completing the series of acts 400, the image relevance system 210 has obtained or generated a text embedding based on the category label of the entity identifier. Next, the image relevance system 210 obtains an image embedding, which is described in the following section.

As mentioned above, FIG. 5 provides additional details about generating image embeddings. In particular, FIG. 5 illustrates an example flow diagram of determining image embeddings for an image according to some implementations. As shown, FIG. 5 includes a series of acts 500 performed by or with the image relevance system 210 to generate image embeddings.

The series of acts 500 includes act 502 of obtaining an entity identifier based on user input in a user query. As mentioned above, in response to a user query that includes user input, the image relevance system 210 or another system (e.g., a user query system) can identify an entity included or inferred in the user input. The system then identifies an entity identifier associated with the entity. In some implementations, the image relevance system 210 obtains an entity identifier of an entity not in connection with a user query. For example, the image relevance system 210 automatically or manually assesses category-based image relevance and removes irrelevant images associated with an entity.

Act 504 includes identifying an entity-based image set based on the entity identifier. In various implementations, upon obtaining the entity identifier, the image relevance system 210 uses the entity identifier to identify one or more images associated with the entity identifier. For example, the image relevance system 210 identifies some or all of the images tagged or assigned to the entity identifier. If the number of identified images is above an upper image count limit, the image relevance system 210 may identify a subset of images associated with the entity identifier. In one or more implementations, the image relevance system 210 generates an image set with some or all of the images associated with an entity identifier.

In various implementations, some images are associated with multiple entity identifiers. In these instances, these images may belong to multiple entity-based image sets. In one or more implementations, an image set includes a listing of images associated with the entity identifier and locations where the images can be accessed and does not include the image files themselves.

The series of acts 500 branches into two paths. The first path includes act 506 and includes obtaining image embeddings from an image embedding data store. For example, image embeddings for one or more of the images in the entity-based image set have been previously generated and the image relevance system 210 receives copies of these image embeddings. In some instances, the image embeddings are stored in an image embedding data store accessible to the image relevance system 210.

The second path includes act 508 of generating one or more image embeddings for images not in the image embedding data store. For instance, if an image embedding for an image in the image set is not included in the data store or is not accessible, the image relevance system 210 may generate the image embedding by providing the image as an input to the image embedding neural network, as described above, to generate the image embedding.

With both the text embedding and the image embedding, the image relevance system 210 can generate a similarity score, as described above in connection with FIG. 3. Furthermore, the image relevance system 210 can compare the similarity score to the category-specific relevance threshold for the category label (e.g., the category label associated with the text embedding) to determine if the image is an outlier for the entity-based image set. Determining category-specific relevance thresholds for categories is described next.

As mentioned above, FIG. 6 provides additional details about category-specific relevance thresholds for category labels. In particular, FIG. 6 illustrates an example flow diagram for determining a category-specific relevance threshold for a category label according to some implementations. FIG. 6 includes a series of acts 600 performed by or with the image relevance system 210.

The series of acts 600 includes a first row of acts including act 602 of identifying a category label from a category label hierarchy with multiple category labels. For instance, the image relevance system 210 identifies a category label from one of the levels in the category hierarchy for a category. The image relevance system 210 may repeat the series of acts 600 for different levels in the same category hierarchy to determine a different category-specific relevance threshold for each level. If a category does not have a hierarchy, the image relevance system 210 may identify the base category label for the category.

Act 604 includes identifying a collection of images associated with the category label. For example, the image relevance system 210 accesses a corpus of images and identifies some or all of the images associated with the category label. In some implementations, the image relevance system 210 works with another system, such as an image retrieval system to identify a collection of images associated with the category label.

The images in the collection can be associated with multiple entity identifiers (or no entity identifiers). Indeed, act 604 is performed independently of which entity identifiers are assigned to images. Instead, act 604 includes obtaining a collection of images that correspond to the selected or identified category label. In many instances, many images are associated with multiple category labels, such as different category hierarchy labels in the same category as well as category labels from different categories.

In various implementations, the image relevance system 210 selects images from the collection up to a collection limit. For instance, upon identifying images associated with the category label, the image relevance system 210 randomly selects images up to the collection limit (e.g., 1000, 3000, 5500, or 10000 images). In some implementations, the image relevance system 210 selects images based on recency or correlation strength to the category label.

The series of acts 600 continues with a second row of acts, which corresponds to creating a training dataset for the category label in the image relevance system 210, which is then used to determine a similarity threshold for the category label. To illustrate, the second row of acts in FIG. 6 includes act 606 of generating an image relevance prompt for the collection of images. In various implementations, the image relevance system 210 creates a prompt for a generative artificial intelligence (AI) model to determine the relevance of each image in the collection of images to the category label.

To elaborate, in various implementations, the image relevance prompt includes instructions for the generative AI model to determine a relevance score for each image in the candidate image from the collection of images based on its relevance to the category label. In various implementations, the image relevance prompt includes examples of relevance scores and/or other criteria for scoring image relevance. In some instances, the generative AI model is instructed to generate a score that ranges from 0 to 100 (or another scale). In some implementations, the generative AI model is instructed to generate a binary score of 0 or 1 indicating whether a candidate image is relevant (1) or not relevant (0) to the category label.

Act 608 includes providing the image relevance prompt to the generative AI model. In various implementations, the prompt includes, or is provided with, the collection of images and the category label. In some implementations, the prompt provides access to the collection of images. In response, the generative AI model processes each candidate image and provides a relevance score.

Act 610 includes receiving a relevance score for each image in the image collection. For instance, the generative AI model returns a relevance score for each image. In implementations where the relevance score is binary, the generative AI model may return a list of relevant images and/or irrelevant images.

The series of acts 600 continues with a third row of acts, which corresponds to preparing a training dataset that can be used to determine a similarity threshold for the category label. To illustrate, the third row of acts in FIG. 6 includes act 612 of generating a set of training images that includes positive and negative images based on the relevance score. For example, the image relevance system 210 divides the collection of images into positive, relevant images and negative, irrelevant images. If binary relevance scores are not used, the image relevance system 210 may use a predetermined threshold to divide the images into positive and negative image groups or subsets. These two groups of images form an image training set for the category label.

Act 614 includes generating a set of image embeddings for the training images. In various implementations, the image relevance system 210 (or another system) generates image embeddings for each of the images in the image training set. In some implementations, the image relevance system 210 obtains previously generated image embeddings.

In various implementations, the image relevance system 210 tags, labels, or otherwise associates each image embedding as either relevant (e.g., positive) or irrelevant (e.g., negative) to the category label. In some implementations, the image relevance system 210 organizes the image embeddings into separate relevance groups (e.g., a positive group or a negative group).

Act 616 includes generating a set of similarity scores between the set of image embeddings and a text embedding for the category label. As described above, the image relevance system 210 can generate similarity scores between a category label text embedding and image embeddings. In these cases, the image relevance system 210 generates a similarity score for each image in the collection of images.

Additionally, the image relevance system 210 can associate the similarity scores with relevant (e.g., positive) and irrelevant (e.g., negative) images. For example, the image relevance system 210 tags or labels each similarity score as being associated with a positive or negative image. In various implementations, the image relevance system 210 organizes the similarity scores into separate relevance groups (e.g., a positive group or a negative group).

Using the similarity scores for the training images, the image relevance system 210 can determine a threshold level specifically tailored to the category label. To illustrate, the fourth row of acts in the series of acts 600 includes act 618 of mapping the set of similarity scores to a graphical plot curve. In various implementations, the image relevance system 210 maps the positive and negative similarity scores onto a map or graph in a graphical plot curve. By using a graphical plot curve, the image relevance system 210 can analyze the accuracy of the embeddings against measurements such as precision and recall.

To elaborate, in various implementations, the curve represents a receiver operating characteristic (ROC) curve. A ROC curve is a graphical plot that can be used to evaluate a binary classifier system (e.g., relevant versus irrelevant images) at different discrimination thresholds. In some instances, a ROC curve uses positive values plotted against negative values at various threshold settings.

A receiver operating characteristic (ROC) curve is a graphical plot used to evaluate the performance of a binary classifier system (e.g., classifying images as relevant or irrelevant) at different discrimination thresholds. The ROC curve is created by plotting the true positive rate (TPR) against the false positive rate (FPR) at various threshold settings. For example, TPR (also known as sensitivity or recall) represents the proportion of positive, relevant images that are correctly identified as being associated with the classification label. FPR, on the other hand, represents the proportion of actual negative, irrelevant images that were incorrectly associated with the category label. Together, the ROC curve shows how the classification performance changes across different threshold settings and provides a comprehensive view of the trade-off between the TPR and FPR for every possible cutoff.

Act 620 includes determining the category-specific threshold for the category label based on the graphical plot curve. In various implementations, the image relevance system 210 evaluates the graphical plot curve to determine a precise value to assign as the threshold for the category label.

In one or more implementations, when the graphical plot curve is a ROC curve, the image relevance system 210 uses an area under the ROC curve (AUC-ROC or AUC) measurement to determine the category-specific threshold for the category label. In many instances, using AUC, the image relevance system 210 identifies the threshold value for the category label that maximizes both precision and recall.

As mentioned above, in various implementations, the image relevance system 210 repeats the series of acts for multiple category labels. For example, the image relevance system 210 determines a separate category-specific threshold for different categories in a category taxonomy. Additionally, the category-specific threshold can determine a separate category-specific threshold for category hierarchy levels of the same category. By doing so, the image relevance system 210 ensures an accurate evaluation of images as outliers by comparing them to corresponding category-specific thresholds.

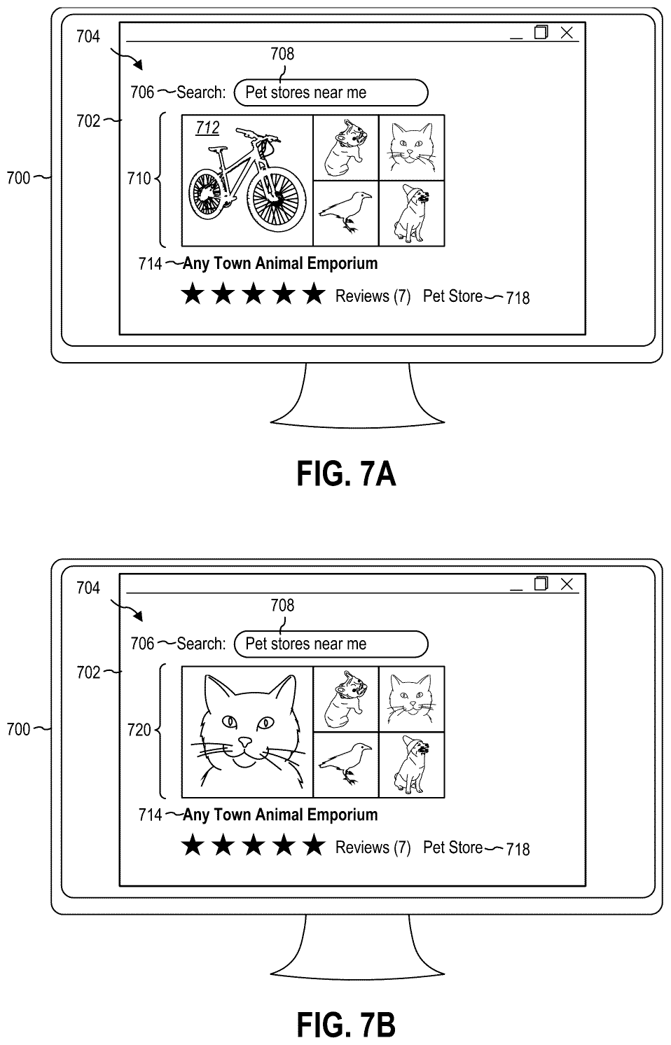

FIGS. 7A-7B illustrate example graphical user interface diagrams for providing search results with a topic-specific image set before (FIG. 7A) and after (FIG. 7B) the image relevance system determines and removes an outlier image according to some implementations. As shown in FIGS. 7A-7B, there is a computing device 700, which may correspond to the client device 270 introduced above and may be associated with a user. The computing device 700 includes a client application 702, such as a web browser.

As shown in FIGS. 7A-7B, the client application 702 allows a user to access a search engine website 704. The search engine website 704 includes a search function 706 that receives user queries with user input 708 from a user. As illustrated in both FIGS. 7A-7B, the search engine website 704 displays query results in response to receiving a user query that includes the user input 708 of “Pet stores near me.”

The query results are a multimodal response that provides entity information for an entity 714 called “Any Town Animal Emporium.” Additionally, the query results show that the entity 714 is associated with a category label 718 of “Pet Store.” While not shown, the entity 714 may include additional category labels, such as higher-level (e.g., more general) category hierarchy labels. The query results also include an image set associated with the entity 714, which differs between FIG. 7A and FIG. 7B.

In FIG. 7A, the image set 710 includes various images tagged as being associated with the entity 714. However, as shown, while each of the images in the image set 710 is associated with the entity 714, the image set 710 includes an outlier image 712 that is not relevant to the entity 714. When the image relevance system 210 is not implemented, one or more irrelevant or outlier images are often included when providing entity-based image sets.

FIG. 7B shows an updated image set 720 where the outlier image 712 has been removed before providing results. For example, the image relevance system 210 determines that the outlier image is irrelevant and removes it from the entity-based image set before the images are provided as part of the query results.

In various implementations, the image relevance system 210 also provides relevance rankings of images in an entity-based image set. Images provided in response to a user query may be selected and/or organized based on their relevance ranking. As described above, the image relevance system 210 may rank images in an entity-based image set based on their relevance to the entity identified in the user input as well as any additional keywords included in the user input. By doing so, the image relevance system 210 allows for more tailored and customized image results in response to user queries. For example, for the user query of “Eiffel Tower at night,” the updated image set removes and/or demotes images associated with the Eiffel Tower, but that are not taken at night, to not be displayed and/or displayed after nighttime images.

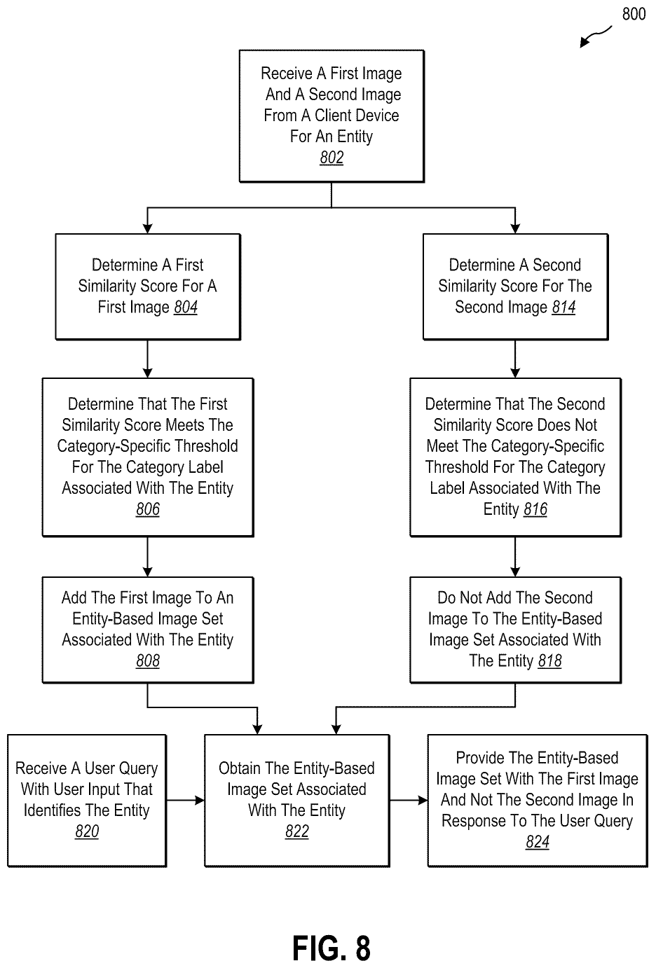

In addition to using the image relevance system 210 to detect and remove outlier images from user query results, the image relevance system 210 may also be used to prevent adding outlier images to an entity-based image set. To elaborate, FIG. 8 illustrates an example flow diagram of adding relevant images to a topic-specific image set. As shown, FIG. 8 includes a series of acts 800 performed by or with the image relevance system 210.

The series of acts 800 includes act 802 of receiving a first image and a second image from a client device for an entity. For example, a user provides a review of a restaurant that includes multiple images of their restaurant experience. With current systems, the images are automatically tagged to the entity and will appear in future user queries about the entity. However, this poses a problem when one or more of the images are not relevant to the entity. Additionally, unless the content is specifically tagged or labeled, they may still be provided in results even when less relevant to a specific user query.

As shown, the series of acts 800 branches into two paths. The first path includes act 804 of determining a first similarity score for the first image. For instance, as described above, the image relevance system 210 combines a category label text embedding with an image embedding of the first image to generate a first similarity score.

Act 806 in the first path includes determining that the first similarity score meets the category-specific threshold for the category label associated with the entity. In various implementations, the image relevance system 210 compares the first similarity score to the category-specific threshold, as described above, and determines that the first image is relevant to other images associated with the entity. Accordingly, the image relevance system 210 adds the first image to an entity-based image set associated with the entity, as shown in act 808.

In the second path, the series of acts 800 includes act 814 of determining a second similarity score for the second image. For instance, the image relevance system 210 combines the category label text embedding with an image embedding of the second image to generate a second similarity score, as described above.

Act 816 in the second path includes determining that the second similarity score does not meet the category-specific threshold for the category label associated with the entity. For example, the image relevance system 210 compares the second similarity score to the category-specific threshold and determines that the second image is not relevant to the entity. Accordingly, the image relevance system 210 does not add the second image to the entity-based image set associated with the entity, as shown in act 818. Indeed, the image relevance system 210 prevents the irrelevant second image from being associated with the entity.

The series of acts 800 includes a lower path along the bottom of FIG. 8. This lower path may occur at a future time. As shown, the lower path includes act 820 of receiving a user query with user input that identifies the entity. As described above, in responding to the user query, the image relevance system 210 or a related system (e.g., a user query screenshot) obtains the entity-based image set associated with the entity, as shown in act 822.

As described above, in various instances, one or more images from the entity-based image set associated with the entity are provided within query results in response to the image quality. In particular, act 824 includes providing the entity-based image set with the first images and not the second image in response to the user query. Because the image relevance system 210 prevents the second image from being added to the entity-based image set associated with the entity, the second image is not provided with other images from the entity-based image set.

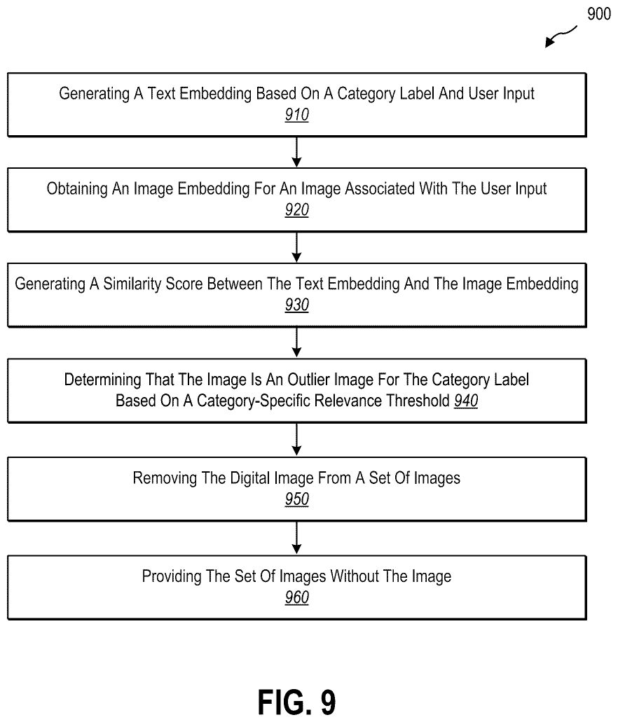

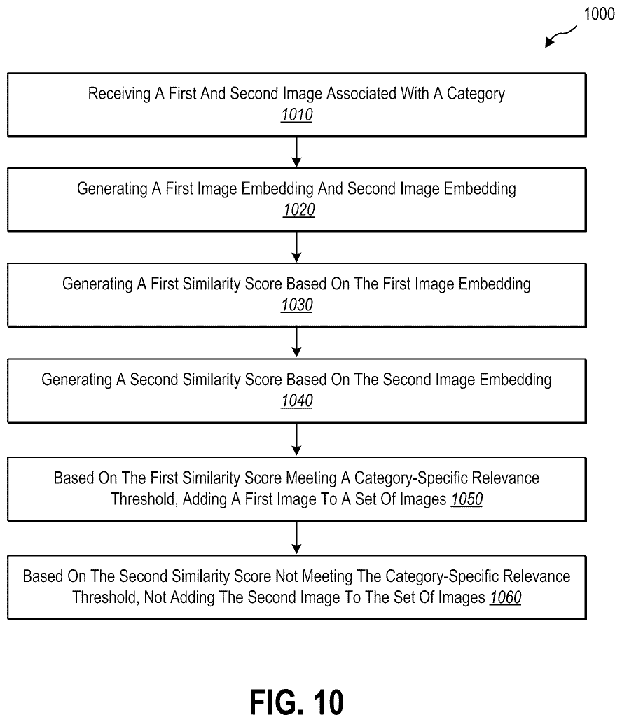

Turning now to FIG. 9 and FIG. 10, these figures each illustrate an example series of acts of a computer-implemented method for determining the image relevance of a digital image based on a category-specific embedding and/or determining the image relevance for digital images based on category-specific embeddings according to some implementations. While FIG. 9 and FIG. 10 each illustrate acts according to one or more implementations, alternative implementations may omit, add to, reorder, and/or modify any of the acts shown.

The acts in FIG. 9 and FIG. 10 can be performed as part of a method (e.g., a computer-implemented method). Alternatively, a computer-readable medium can include instructions that, when executed by a processing system with a processor, cause a computing device to perform the acts in FIG. 9 and FIG. 10. In some implementations, a system (e.g., a processing system comprising a processor) can perform the acts in FIG. 9 and FIG. 10. For example, the system includes a processing system and a computer memory including instructions that, when executed by the processing system, cause the system to perform various actions or steps.

In particular, FIG. 9 corresponds to an example series of acts of a computer-implemented method for determining the image relevance of a digital image based on a category-specific embedding. As shown, the series of acts 900 includes act 910 of generating a text embedding based on a category label and user input. For instance, in example implementations, act 910 involves generating a text embedding based on a category label and user input, where the category label is selected from a set of category labels based on the user input. In some implementations, act 910 includes identifying a set of hierarchical category labels associated with the user input, and selecting the category label from the set of hierarchical category labels based on the category label having the most specific hierarchy among category labels within the set of hierarchical category labels. In some implementations, obtaining the text embedding includes generating the text embedding for the category label before receiving the user input, storing the text embedding in a text embedding data store, determining that the user input is associated with the category label upon receiving the user input, and obtaining the text embedding for the category label from the text embedding data store.

In some implementations, as part of act 910, generating the text embedding includes identifying the category label based on the user input, creating or generating a combined text string based on the category label and the user input, and generating the text embedding by providing the combined text string to a text encoder neural network. In one or more implementations, generating the text embedding includes identifying a category label text embedding based on the user input, generating a user input text embedding by providing the user input to a text encoder neural network, and generating the text embedding by combining the category label text embedding and the user input text embedding.

As further shown, the series of acts 900 includes act 920 of obtaining an image embedding for an image associated with the user input. For instance, in example implementations, act 920 involves obtaining an image embedding for an image belonging to a set of images identified based on the user input. In some implementations, as part of act 920, obtaining the image embedding includes generating the image embedding by providing the image to an image encoder neural network to generate the image embedding.

As further shown, the series of acts 900 includes act 930 of generating a similarity score between the text embedding and the image embedding. For instance, in example implementations, act 930 involves generating a similarity score by combining the text embedding and the image embedding.

In some implementations, act 930 includes identifying a collection of candidate images associated with the category label, providing the collection of candidate images to a generative artificial intelligence (AI) model with instructions to determine relevance scores between each candidate image and the category label, generating a set of training images that classify the collection of candidate images into a positive subset of candidate images having relevance scores that meet a relevance score threshold and a negative subset of candidate images having relevance scores that do not meet a relevance score threshold, and determining the category-specific relevance threshold for the category label based on the set of training images.

In some implementations, determining the category-specific relevance threshold for the category label includes generating a set of image encodings for the set of training images using an image encoding neural network, generating a set of similarity scores for the set of training images by combining the set of image encodings with the text embedding of the category label, mapping the set of similarity scores to a mapping space to generate a graphical plot curve, and determining the category-specific relevance threshold for the category label based on applying an algorithm or measurement to the graphical plot curve. In various implementations, the graphical plot curve is a receiver operating characteristic (ROC) curve, and applying the algorithm or measurement to the graphical plot curve includes determining the category-specific relevance threshold for the category label based on an area under the ROC curve measurement or algorithm.

In some implementations, the collection of candidate images associated with the category label is received from an image retrieval system. In some implementations, the relevance scores for each candidate image include a binary relevance score indicating whether a candidate image is relevant to the category label. In some implementations, generating the similarity score includes determining the cosine similarity between the text embedding and the image embedding.

In various implementations, act 930 includes providing a collection of candidate images associated with the category label to a generative artificial intelligence (AI) model with instructions to determine which of the collection of candidate images are relevant to the category label, generating a set of training images that classify the collection of candidate images into a positive subset of relevant candidate images and a negative subset of irrelevant or nonrelevant candidate images, generating a set of image encodings for the set of training images using an image encoding neural network, generating a set of similarity scores for the set of training images by combining the set of image encodings with the text embedding of the category label, and determining the category-specific relevance threshold for the category label based on the set of similarity scores.

As shown further, the series of acts 900 includes act 940 of determining that the image is an outlier image for the set of images based on a category-specific relevance threshold. For instance, in example implementations, act 940 involves determining that the image is an outlier image for the set of images by comparing the similarity score to a category-specific relevance threshold, where the category-specific relevance threshold is selected from a set of category-specific relevance thresholds associated with the set of category labels. In some implementations, as part of act 940, determining that the image is an outlier image for the set of images includes determining that the similarity score does not meet the category-specific relevance threshold for the category label.

As further shown, the series of acts 900 includes act 950 of removing the image from a set of images. In some instances, in example implementations, act 950 involves removing the image from the set of images based on the image being an outlier image for the set of images.

As further shown, the series of acts 900 includes act 960 of providing the set of images without the image. In some instances, in example implementations, act 960 involves providing the set of images without the outlier image in response to the user input. In some implementations, as part of act 960, providing the set of images without the outlier image in response to the user input includes combining the set of images and a text response responding to a user query into a multimodal response, where the user input includes the user query and providing the multimodal response in response to the user query.

In some implementations, the series of acts 900 includes generating similarity scores between multiple image embeddings of multiple images in the set of images and the text embedding, and ranking the multiple images based on corresponding similarity scores. In some implementations, providing the set of images in response to the user input includes providing one or more of the multiple images in the set of images based on similarity score rankings.

In various implementations, the series of acts 900 includes obtaining an additional image embedding for an additional image that belongs to the set of images, generating an additional similarity score by combining the text embedding and the additional image embedding, determining that the additional image is not an outlier image for the set of images based on the additional similarity score meeting the category-specific relevance threshold, and providing the set of images with the additional image in response to the user input. In various implementations, the series of acts 900 includes receiving a user query that includes the user input, where the user input indicates an entity, determining an entity identifier for the entity based on the user input, determining the category label assigned to the entity identifier, and identifying the set of images based on the set of images being associated with the entity identifier.

In some implementations, the series of acts 900 includes identifying an entity identifier based on user input included in a user query; generating a text embedding by providing a category label and the user input to a text encoding neural network, where the category label is selected from a set of category labels based on the entity identifier; obtaining an image embedding for an image belonging to a set of images associated with the entity identifier from an image data store; generating a similarity score by combining the text embedding and the image embedding; determining that the image is an outlier image for the set of images associated with the entity identifier based on comparing the similarity score to a category-specific relevance threshold, where the category-specific relevance threshold is selected from a set of category-specific relevance thresholds associated with the set of category labels; removing the image from the set of images for the entity identifier based on the image being an outlier image for the set of images; and providing the set of images for the entity identifier without the outlier image in response to the user input.

Turning to FIG. 10, this figure corresponds to an example series of acts of a computer-implemented method for determining the relevance of digital images based on category-specific embeddings according to some implementations. As shown, the series of acts 1000 includes act 1010 of receiving a first and second image associated with a category. For instance, in example implementations, act 1010 involves receiving a first image and a second image associated with a category label. In various implementations, as part of act 1010, the set of images corresponds to images associated with a business entity assigned with the category label. In some implementations, the first image and the second image are received to supplement the set of images associated with the business entity.

As further shown, the series of acts 1000 includes act 1020 of generating a first image embedding and a second image embedding. For instance, in example implementations, act 1020 involves generating a first image embedding for the first image and a second image embedding for the second image.

As further shown, the series of acts 1000 includes act 1030 of generating a first similarity score based on the first image embedding. For instance, in example implementations, act 1030 involves generating a first similarity score between a text embedding for the category label and the first image embedding.

As shown further, the series of acts 1000 includes act 1040 of generating a second similarity score based on the second image embedding. For instance, in example implementations, act 1040 involves generating a second similarity score between the text embedding for the category label and the second image embedding.

As further shown, the series of acts 1000 includes act 1050 of adding the first image to a set of images based on the first similarity score meeting a category-specific relevance threshold. In some instances, in example implementations, act 1050 involves adding the first image to a set of images associated with the category label based on the first similarity score meeting a category-specific relevance threshold for the category label.

As further shown, the series of acts 1000 includes act 1060 of not adding the second image to the set of images based on the second similarity score not meeting the category-specific relevance threshold. In some instances, in example implementations, act 1060 involves not adding the second image to the set of images associated with the category label based on the second similarity score not meeting the category-specific relevance threshold for the category label. In various implementations, the series of acts 1000 includes receiving user input from a user query indicating the business entity, identifying the set of images based on comparing a text embedding of the user input to image embeddings of the set of images to determine similarities and providing the set of images in response to the user input.

FIG. 11 illustrates certain components that may be included within a computer system 1100. The computer system 1100 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1100 represents one or more of the client devices, server devices, or other computing devices described above. For example, the computer system 1100 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1100 includes a processing system including a processor 1101. The processor 1101 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1101 may be referred to as a central processing unit (CPU) and may cause computer-implemented instructions to be performed. Although the processor 1101 shown is just a single processor in the computer system 1100 of FIG. 11, in an alternative configuration, a combination of processors (e.g., an ARM and DSP) could be used.

The computer system 1100 also includes memory 1103 in electronic communication with the processor 1101. The memory 1103 may be any electronic component capable of storing electronic information. For example, the memory 1103 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1105 and the data 1107 may be stored in the memory 1103. The instructions 1105 may be executable by the processor 1101 to implement some or all of the functionality disclosed herein. Executing the instructions 1105 may involve the use of the data 1107 stored in the memory 1103. Any of the various examples of modules and components described herein may be implemented, partially or wholly, as instructions 1105 stored in memory 1103 and executed by the processor 1101. Any of the various examples of data described herein may be among the data 1107 stored in memory 1103 and used during the execution of the instructions 1105 by the processor 1101.

A computer system 1100 may also include one or more communication interface(s) 1109 for communicating with other electronic devices. The one or more communication interface(s) 1109 may be based on wired communication technology, wireless communication technology, or both. Some examples of the one or more communication interface(s) 1109 include a Universal Serial Bus (USB), an Ethernet adapter, a wireless adapter that operates according to an Institute of Electrical and Electronics Engineers (IEEE) 1102.11 wireless communication protocol, a Bluetooth® wireless communication adapter, and an infrared (IR) communication port.

A computer system 1100 may also include one or more input device(s) 1111 and one or more output device(s) 1113. Some examples of the one or more input device(s) 1111 include a keyboard, mouse, microphone, remote control device, button, joystick, trackball, touchpad, and light pen. Some examples of the one or more output device(s) 1113 include a speaker and a printer. A specific type of output device typically included in a computer system 1100 is a display device 1115. The display device 1115 used with implementations disclosed herein may utilize any suitable image projection technology, such as liquid crystal display (LCD), light-emitting diode (LED), gas plasma, electroluminescence, or the like. A display controller 1117 may also be provided for converting data 1107 stored in the memory 1103 into text, graphics, and/or moving images (as appropriate) shown on the display device 1115.

The various components of the computer system 1100 may be coupled together by one or more buses, which may include a power bus, a control signal bus, a status signal bus, and a data bus. For clarity, the various buses are illustrated in FIG. 11 as a bus system 1119.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transportation of electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Instead, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to exclude the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for determining image relevance of a digital image based on a category-specific embedding, comprising:
generating a text embedding based on a category label and user input, wherein the category label is selected from a set of category labels based on the user input;
obtaining an image embedding for an image belonging to a set of images identified based on the user input;
generating a similarity score by combining the text embedding and the image embedding;
determining that the image is an outlier image for the set of images based on comparing the similarity score to a category-specific relevance threshold, wherein the category-specific relevance threshold is selected from a set of category-specific relevance thresholds associated with the set of category labels;
removing the image from the set of images based on the image being an outlier image for the set of images; and
providing the set of images without the outlier image in response to the user input.

2. The computer-implemented method of claim 1, wherein generating the text embedding includes:
identifying the category label based on the user input;
generating a combined text string based on the category label and the user input; and
generating the text embedding by providing the combined text string to a text encoder neural network.

3. The computer-implemented method of claim 1, wherein generating the text embedding includes:
identifying a category label text embedding based on the user input;
generating a user input text embedding by providing the user input to a text encoder neural network; and
generating the text embedding by combining the category label text embedding and the user input text embedding.

4. The computer-implemented method of claim 1, further comprising:
identifying a set of hierarchical category labels associated with the user input; and
selecting the category label from the set of hierarchical category labels based on the category label having a most specific hierarchy among category labels within the set of hierarchical category labels.

5. The computer-implemented method of claim 1, wherein generating the similarity score includes determining a cosine similarity between the text embedding and the image embedding.

6. The computer-implemented method of claim 1, wherein determining that the image is an outlier image for the set of images includes determining that the similarity score does not meet the category-specific relevance threshold for the category label.

7. The computer-implemented method of claim 1, wherein providing the set of images without the outlier image in response to the user input includes:
combining the set of images and a text response responding to a user query into a multimodal response, the user input including the user query; and
providing the multimodal response in response to the user query.

8. The computer-implemented method of claim 1, further comprising:
generating similarity scores between multiple image embeddings of multiple images in the set of images and the text embedding; and
ranking the multiple images based on corresponding similarity scores,
wherein providing the set of images in response to the user input includes providing one or more of the multiple images in the set of images based on similarity score rankings.

9. The computer-implemented method of claim 1, further comprising:
obtaining an additional image embedding for an additional image belonging to the set of images;
generating an additional similarity score by combining the text embedding and the additional image embedding;
determining that the additional image is not an outlier image for the set of images based on the additional similarity score meeting the category-specific relevance threshold; and
providing the set of images with the additional image in response to the user input.

10. The computer-implemented method of claim 1, further comprising:
identifying a collection of candidate images associated with the category label;
providing the collection of candidate images to a generative artificial intelligence (AI) model with instructions to determine relevance scores between each candidate image and the category label;
generating a set of training images that classify the collection of candidate images into a positive subset of candidate images having relevance scores that meet a relevance score threshold and a negative subset of candidate images having relevance scores that do not meet a relevance score threshold; and
determining the category-specific relevance threshold for the category label based on the set of training images.

11. The computer-implemented method of claim 10, wherein the collection of candidate images associated with the category label is received from an image retrieval system.

12. The computer-implemented method of claim 10, wherein the relevance scores for each candidate image include a binary relevance score indicating whether a candidate image is relevant to the category label.

13. The computer-implemented method of claim 10, wherein determining the category-specific relevance threshold for the category label includes:
generating a set of image encodings for the set of training images using an image encoding neural network;
generating a set of similarity scores for the set of training images by combining the set of image encodings with the text embedding of the category label;
mapping the set of similarity scores to a mapping space to generate a graphical plot curve; and
determining the category-specific relevance threshold for the category label based on applying a measurement to the graphical plot curve.

14. The computer-implemented method of claim 13, wherein:
the graphical plot curve is a receiver operating characteristic (ROC) curve; and
applying the measurement to the graphical plot curve includes determining the category-specific relevance threshold for the category label based on an area under the ROC curve measurement.

15. The computer-implemented method of claim 1, further comprising:
receiving a user query that includes the user input, wherein the user input indicates an entity;
determining an entity identifier for the entity based on the user input;
determining the category label assigned to the entity identifier; and
identifying the set of images based on the set of images being associated with the entity identifier.

16. A system comprising:
a processing system having a processor; and
a computer memory including instructions that, when executed by the processing system, cause the system to carry out operations comprising:
obtaining a text embedding for a category label determined based on user input, wherein the category label is selected from a set of category labels;
obtaining an image embedding for an image belonging to a set of images identified based on the user input;
generating a similarity score by combining the text embedding and the image embedding;
determining that the image is an outlier image for the set of images based on comparing the similarity score to a category-specific relevance threshold, wherein the category-specific relevance threshold is selected from a set of category-specific relevance thresholds associated with the set of category labels;
removing the image from the set of images based on the image being an outlier image for the set of images; and
providing the set of images without the outlier image in response to the user input.

17. The system of claim 16, further comprising instructions that, when executed by the processing system, cause the system to carry out operations comprising:
providing a collection of candidate images associated with the category label to a generative artificial intelligence (AI) model with instructions to determine which of the collection of candidate images are relevant to the category label;
generating a set of training images that classify the collection of candidate images into a positive subset of relevant candidate images and a negative subset of candidate images;
generating a set of image encodings for the set of training images using an image encoding neural network;
generating a set of similarity scores for the set of training images by combining the set of image encodings with the text embedding of the category label; and
determining the category-specific relevance threshold for the category label based on the set of similarity scores.

18. The system of claim 16, wherein obtaining the text embedding includes:
generating the text embedding for the category label before receiving the user input;
storing the text embedding in a text embedding data store;
upon receiving the user input, determining that the user input is associated with the category label; and
obtaining the text embedding for the category label from the text embedding data store.

19. The system of claim 16, wherein obtaining the image embedding includes generating the image embedding by providing the image to an image encoder neural network to generate the image embedding.

20. A computer-implemented method for determining image relevance of a digital image based on a category-specific embedding, comprising:
identifying an entity identifier based on user input included in a user query;
generating a text embedding by providing a category label and the user input to a text encoding neural network, wherein the category label is selected from a set of category labels based on the entity identifier;
obtaining, from an image data store, an image embedding for an image belonging to a set of images associated with the entity identifier;
generating a similarity score by combining the text embedding and the image embedding;
determining that the image is an outlier image for the set of images associated with the entity identifier based on comparing the similarity score to a category-specific relevance threshold, wherein the category-specific relevance threshold is selected from a set of category-specific relevance thresholds associated with the set of category labels;
removing the image from the set of images for the entity identifier based on the image being an outlier image for the set of images; and
providing the set of images for the entity identifier without the outlier image in response to the user input.
